(19) United States
(12) Patent Application Publication
(10) Pub. No.: US 2003/0026316 A1
(43) Pub. Date: Feb. 6, 2003

(54) Wavelength tunable ring lasers

(75) Inventor: Alex Behfar, Ithaca, NY (US)

Correspondence Address: George M. Cooper, P.O. Box 2266 Eads Station, Arlington, VA, 22202, US

(73) Assignee: BINOPTICS, INC.

(21) Appl. No.: 09/918,489

(22) Filed: Aug. 1, 2001

(51) Int. Cl. H01S 3/083

(52) U.S. Cl. 372/94

(57) ABSTRACT

A semiconductor ring-type optical device having an optical cavity with at least one partially transmitting facet which serves as an emergence region for light propagating within the optical cavity has the upper surface of the cavity coated with a conductive layer which is divided into at least two segments so as to provide two separate electrodes to allow application of separate voltages to the two segments. When different voltages are applied, one segment of the laser will carry a lower current density than the other, resulting in a lower gain under the electrode having the lower voltage and causing the generated laser wavelength to experience a shift to shorter wavelengths. Accordingly, variations in the voltage applied to the two electrodes allows tuning of the laser output wavelength.

### BACKGROUND OF THE INVENTION

The present invention relates, in general, to ring-type optical devices, and more particularly to a method and apparatus for providing a ring cavity that is capable of generating a light output that can have different selected wavelengths.

Advances in current monolithic integration technology have allowed optical devices of complicated geometry to be fabricated, including ring lasers with a variety of cavity configurations. Examples of such ring lasers are found in U.S. Pat. Nos. 4,851,368, issued Jul. 25, 1989 and 4,924,476, issued May 8, 1990, the disclosures of which are hereby incorporated herein by reference. These patents disclose a traveling wave semiconductor laser, and more particularly a triangular ring-type laser utilizing three legs joined at three non-parallel facets, two of which have totally reflective surfaces and the third of which receives optical radiation at an angle between that of the critical angle of the facet and an angle perpendicular to the facet surface. The patents further disclose a method of forming facets at the required angles to obtain traveling wave operation, and in particular relate to a chemically assisted ion beam etching process for this purpose.

Other examples of ring lasers are found in U.S. Pat. No. 5,132,983, issued Jul. 21, 1992, which discloses optical logic systems utilizing semiconductor ring lasers having multiple segments, and in copending application No.______ of Alex Behfar, filed on even date herewith, and entitled “Curved Waveguide Ring Laser” (Attorney Docket No. 104-128/BIN2), which discloses a ring-type laser having curved cavity segments.

The development of such devices expands the prospective applications for integrated semiconductor lasers, and adds the attractiveness of greater manufacturability and reduced cost. This technology has opened the opportunity to explore new and novel features that can be combined inside and outside semiconductor devices such as laser cavities.

For example, at least in part because of the popularity of the internet, there has been explosive growth in the demand for increased bandwidth in communication systems over the past few years. Carrier companies and their suppliers have addressed this demand by installing Wavelength Division Multiplexing (WDM) systems which allow multiple wavelengths of light to be transmitted through a single strand of optical fiber. Although improving the bandwidth capability of the fiber, this in turn has given rise to a demand for many different lasers, each of which emits light of a specific wavelength. The need to have many lasers, each of which has a different output wavelength, has created a tremendous inventory problem for the carrier companies. Thus, there is a need for an improved technique and apparatus for providing a source capable of emission at multiple wavelengths of light, and more particularly such a source for use with optical fiber transmission lines.

### SUMMARY OF THE INVENTION

Briefly, in one example of the present invention, a semiconductor ring-type optical device is provided, having an optical cavity with at least one partially transmitting facet which serves as an emergence region for light propagating within the optical cavity. Although the device of the invention may take various forms, a ring laser having a triangular cavity or having a loop, or curved, cavity are illustrated in the present disclosure. The upper surface of the cavity is coated with metal, in conventional manner, to provide a contact for applying a bias voltage across the device, with the opposite surface of the cavity also being connected to the bias source through the substrate and a suitable contact. The application of current through the laser device produces lasing action within the body of the laser, creating optical traveling waves of light to propagate around the three sections, or legs, of the triangular laser, with a selected portion of the light being emitted at the facet. In accordance with the present invention, the conductive layer on the upper surface of the laser is divided into at least two segments so as to provide two separate electrodes on that upper surface, to allow application of separate voltages to the two segments. If the electrodes are at the same voltage when the ring laser is generating and propagating optical signals in the cavity, a given wavelength of light is produced by the laser. However, when different voltages are applied, one segment of the laser will carry a lower current density than the other, resulting in a lower gain under the electrode having the lower voltage. For the laser to maintain its emission, the segment under the other electrode must generate more gain than previously, through the passage of a higher current density, thereby causing the generated laser wavelength to experience a shift to shorter wavelengths. Accordingly, variations in the voltage applied to the two electrodes allows tuning of the laser output wavelength.

In one embodiment of the invention, the sections of the laser cavity in between the electrodes are proton-implanted to make them highly resistive in order to prevent a large flow of unwanted current between the electrodes. In another embodiment, the highly doped semiconductor layer in between the two electrodes is removed, also preventing the flow of unwanted current between the electrodes.

A ring cavity laser possesses benefits that a Fabry Perot cavity does not provide; for example, a ring cavity will produce lasing action with higher spectral purity than can be obtained with a Fabry Perot cavity. Therefore, a wavelength tunable ring laser of the type described herein is a desirable component in, for example, wavelength division multiplexing applications.

### BRIEF DESCRIPTION OF THE DRAWINGS

The foregoing, and additional objects, features and advantages of the present invention will be apparent to those of skill in the art from the following detailed description of preferred embodiments thereof, taken in conjunction with the accompanying drawings, in which:

FIG. 1 illustrates a conventional pn junction semiconductor laser;

FIG. 2 illustrates a triangular ring laser;

FIG. 3 illustrates the gain profile of a laser as a function of wavelength for a quantum well for various pump current densities;

FIG. 4 illustrates the behavior of threshold current density as a function of the length of a Fabry Perot quantum well laser such as that illustrated in FIG. 1;

FIG. 5 illustrates the behavior of lasing wavelength at threshold, as a function of the length of a Fabry Perot quantum well laser such as that illustrated in FIG. 1

FIG. 6 is a diagrammatic illustration of a first embodiment of the invention, utilizing a wavelength tunable triangular-shaped ring laser with two electrodes;

FIG. 7 is a diagrammatic illustration of a second embodiment of the invention, utilizing a wavelength tunable curved cavity ring laser with two electrodes;

FIG. 8 diagrammatic illustration of a third embodiment of the invention, utilizing a wavelength tunable triangular-shaped ring laser with two electrodes, wherein the sections of the laser cavity in between two electrodes are proton-bombarded; and

FIG. 9 is a diagrammatic illustration of a fourth embodiment of the invention, utilizing a wavelength tunable triangular-shaped ring laser with two electrodes, wherein the highly doped layer of the sections of the laser cavity in between the two electrodes is removed.

### DESCRIPTION OF PREFERRED EMBODIMENTS

Semiconductor lasers, such as the pn junction laser illustrated at 10 in FIG. 1, typically utilize a semiconductor material such as galium arsenide in which a junction is formed between a p layer 12 and an n layer 14 in the same host lattice so as to form a pn junction 16 which acts as an active layer in the laser. A voltage from a bias source 18 is applied across the junction so that the n-type region in layer 14 is connected to a negative supply, as by way of line 20, and the p-type region in layer 12 is connected through a highly doped p-type region in layer 21 to a positive supply, as by way of line 22, to forward bias the junction 16. The device forms a solid state Fabry-Perot resonant cavity having parallel, semi-reflective end faces, or facets, with the other sets of faces on the sides of the cavity being roughened to suppress light energy in any modes except the mode propagating between the end faces. As illustrated, the bias voltages are applied across the device by way of upper and lower electrodes 24 and 26, respectively, which may be metal layers deposited on the upper and lower surfaces of the laser 10. Such devices are described in greater detail in U.S. Pat. No. 4,924,476.

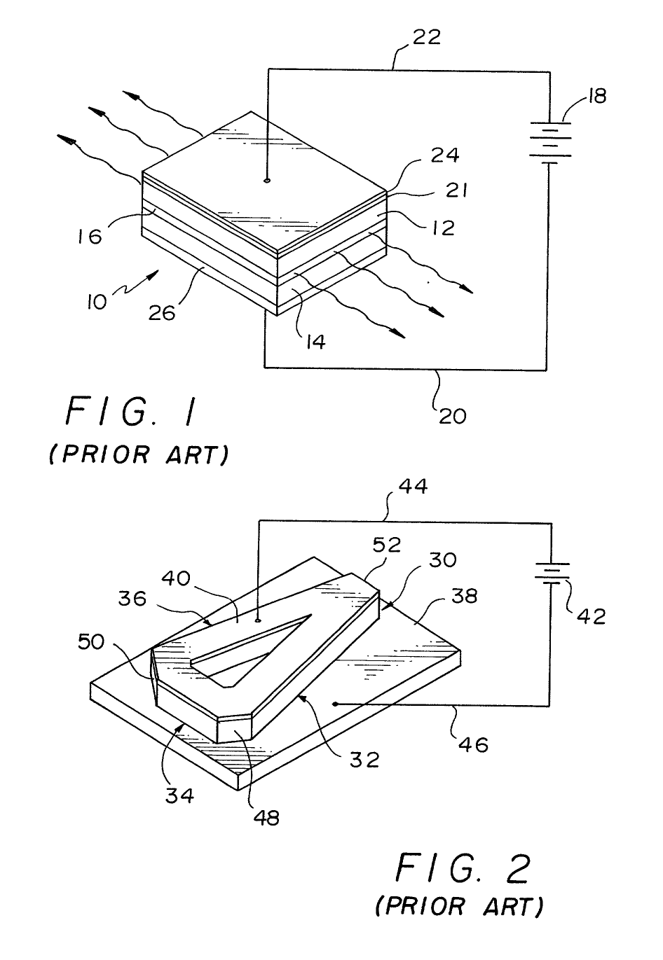

FIG. 2 illustrates a triangular ring laser 30, as fully described in U.S. Pat. No. 4,924,476, which includes three cavity sections 32, 34 and 36 interconnected to form a triangular cavity. As illustrated, the laser preferably is formed as a monolithic structure on a substrate 38. The upper surface of the laser is coated with a metal layer 40 in conventional manner to provide a contact for applying a bias voltage across the device, from source 42 by way of line 44, with the opposite surface of the laser also being connected to the bias source by way of line 46 through a suitable contact such as the substrate 38. Application of a voltage from the bias source 42 across the laser device produces a current flow through the semiconductive body of the laser 30, pumping the quantum wells in the laser and creating optical traveling waves within the three sections 32, 34 and 36. In the triangular form of the laser illustrated in this figure, the three apexes of the triangular cavity meet at, and incorporate, facets such as those illustrated at 48, 50 and 52. The surfaces of these facets are optically smooth, with, for example, facets 48 and 50 providing total internal reflection and facet 52 providing partial transmission to permit emergence of light.

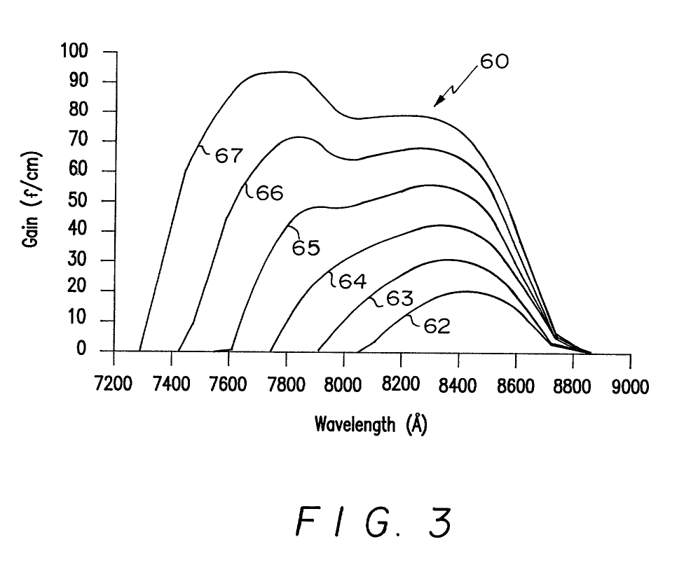

FIG. 3 illustrates in graphical form the manner in which a quantum well has increased gain as the current density pumping the quantum well is increased. Thus, the graph 60 in FIG. 3 illustrates gain vs. wavelength profiles 62-67, each profile representing a different value of current density. These curves show that the peak gain for the various density profiles occurs at shorter wavelengths as the current density pumping the quantum well increases. Thus, for example, the peak gain for the current density level illustrated by curve 62 occurs at about 8450 Angstroms, while the peak gain for the current density represented by curve 65 occurs at about 8350 Angstroms. This behavior has been explained by, for example, Mittelstein et al, Applied Physics Letters, vol. 54, pps. 1092-1094.

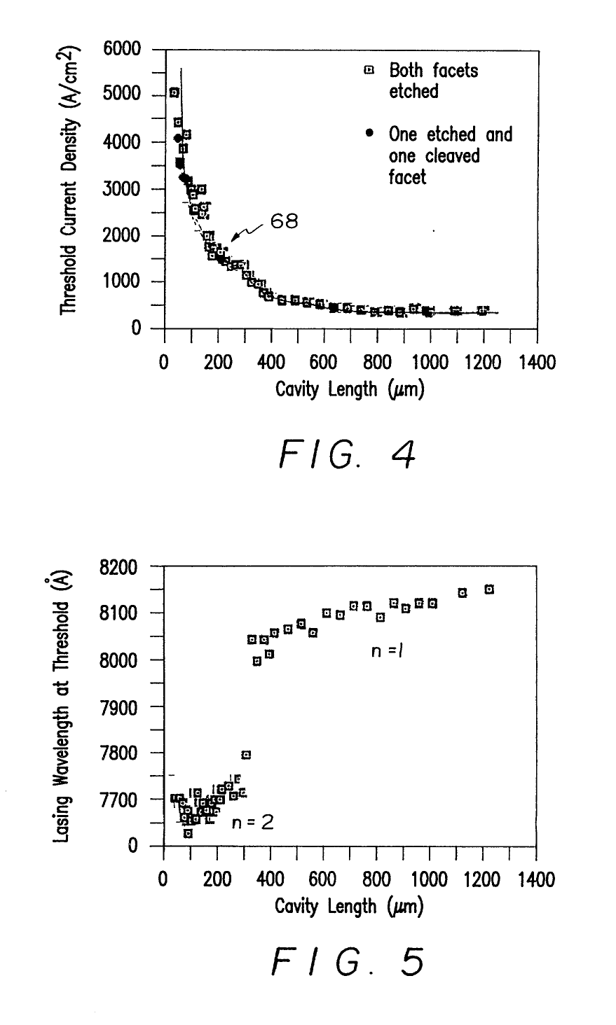

As illustrated in FIG. 4, the threshold current density required to produce a lasing action in Fabry-Perot quantum well lasers such as those illustrated in FIG. 1 has been shown to increase as the cavity length of the laser is reduced. (Behfar-Rad, et al, Applied Physics Letters, vol. 54, pps. 493-495). Curve 68, which indicates threshold current density vs. cavity length for a laser having either both facets etched or one etched and one cleaved, illustrates a marked increase in threshold current density as the cavity length is reduced. Thus, a shorter cavity length Fabry-Perot laser experiences a higher round-trip loss than a longer one with equivalent facets. To compensate for this higher loss, the cavity needs to generate higher gain for the laser in order to reach the threshold value. Therefore, the threshold current density must be higher for a shorter length laser than a longer one.

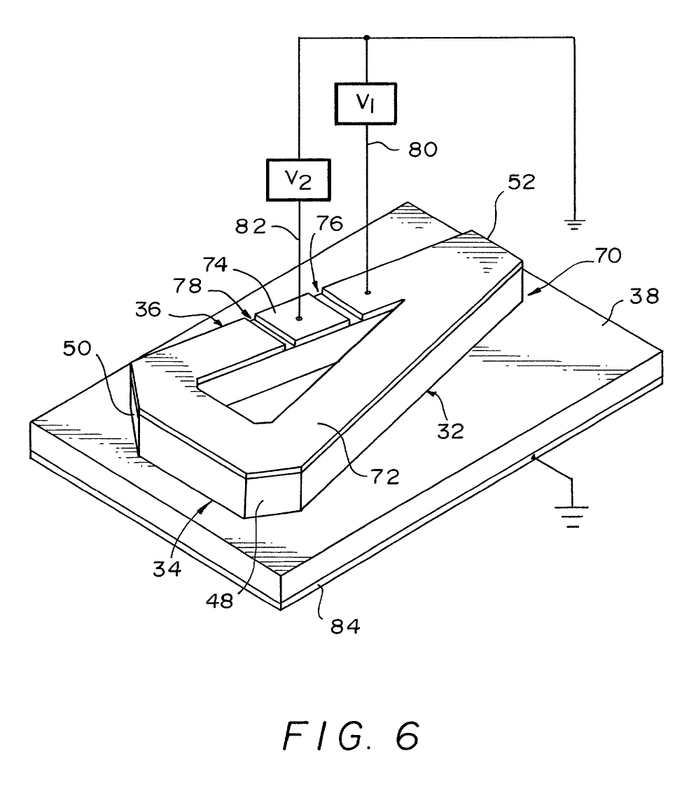

As illustrated in FIG. 5, which charts the lasing wavelength at the threshold current vs. cavity length, the lasing wavelength at threshold drops as cavity length is reduced. This is explained by the fact that the shorter laser has a higher threshold current density and, as illustrated in FIG. 3, the peak gain shifts to shorter wavelengths as higher current densities pump the quantum well. The present invention, illustrated in FIG. 6, takes advantage of these characteristics to provide a tunable wavelength laser.

The ring laser 30 of FIG. 2 is modified, in accordance with the present invention, to provide a ring laser 70 having multiple electrodes in the manner illustrated in FIG. 6, wherein elements common to FIG. 2 are similarly numbered. The top electrode 46 of laser 30 is divided to provide two separate electrodes for the modified laser 70, one electrode being indicated at 72 and the second being indicated at 74, both electrodes being located on the top surface of laser 70 and fabricated in known manner, as by deposition of a metal layer through, for example, metallization lift-off, forming separating gaps 76 and 78. Although two spaced electrodes 72 and 74 are illustrated in FIG. 6, it will be understood that additional spaced-apart electrodes may be fabricated on the surface of laser 70, if desired.

In the illustrated embodiment of FIG. 6, a first bias voltage V₁ is applied to electrode 72 by way of line 80, while a second bias voltage V₂ is connected to electrode 74 by way of line 82. Each of the voltages V₁ and V₂ is variable in order to supply selected voltages to the corresponding electrodes. The bottom surface of the laser 70 may be connected to electrical ground at the back side electrode 84, for example by way of substrate 38, so that voltages are applied between the top and bottom surfaces of the laser.

In the ring laser of FIG. 6, the application of the same voltage (V₁=V₂) to electrodes 72 and 74 will cause the quantum well sections under electrode 72 to receive the same current density as the quantum well section under electrode 74. The light so produced has a given wavelength which is dependent upon the length of the laser cavity as measured by the distance around the ring laser. However, when the bias voltage V₂, which is applied to electrode 74, is reduced below the bias voltage V₁ which is applied to electrode 72, the quantum wells under electrode 74 will receive less current density than the quantum wells of the laser segments under electrode 72. This will result in lower gain, or even a loss, in the section of the laser cavity under electrode 74. For the laser to maintain its emission, the quantum well section under electrode 72 will have to generate more gain than before in order to compensate for the lower gain or the loss in the section under electrode 74. This is achieved by supplying a higher current density through the quantum well section under electrode 72. The result is a shifting of the wavelength of the optical traveling wave in the ring laser to a shorter wavelength. Thus, variation of the value of bias voltage V₂ with respect to the value of bias voltage V₁ permits tuning of the optical wavelength of the light produced by the laser.

For example, if the bias voltages are equal (V₁=V₂), the bias gives rise to a current density of 225 A/cm² through the quantum well under both electrodes 72 and 74. This results in the laser emitting radiation of wavelength 845 nm. Then V₂ is reduced to zero so that the current density through the quantum well under electrode 74 is reduced to zero A/cm². The voltage V, is increased to give rise to a current density of 405 A/cm² to maintain the laser operation and this causes the laser wavelength to shift to 840 nm.

The area under electrode 74 is preferably equal or smaller than the area under electrode 72.

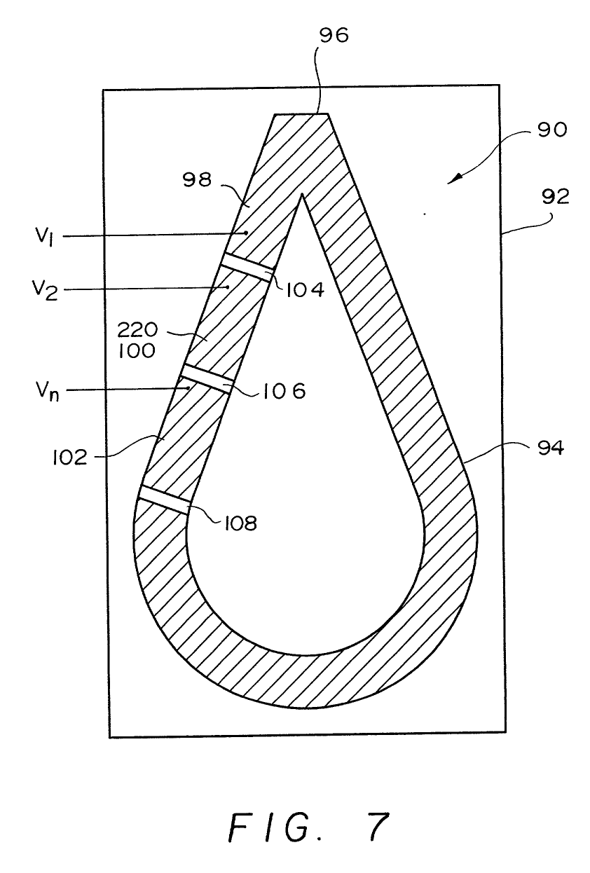

Although the triangular form of the laser illustrated in FIG. 6 is a preferred form of the invention, it will be understood that other ring lasers may equally well be provided with multiple electrodes to permit tuning. Thus, for example, a monolithic curved cavity ring laser, such as that described in the aforesaid Application No.______ (Attorney Docket No. 104-128/BIN2), and illustrated in top plan view at 90 in FIG. 7, may be used to produce a tuned wavelength light output. In this embodiment, the laser 90 is mounted on a substrate 92 and includes a single curved cavity 94 which terminates in a single facet 96. Three electrodes 98, 100, and 102 separated by gaps 104, 106, and 108, are formed on the top surface of cavity 94, and are supplied by corresponding bias voltages V₁, V₂ and Vₙ. Various other cavity shapes, such as those illustrated, for example, in U.S. Pat. No. 5,132,983, may also be provided with varying numbers of electrodes, to allow wavelength tunability.

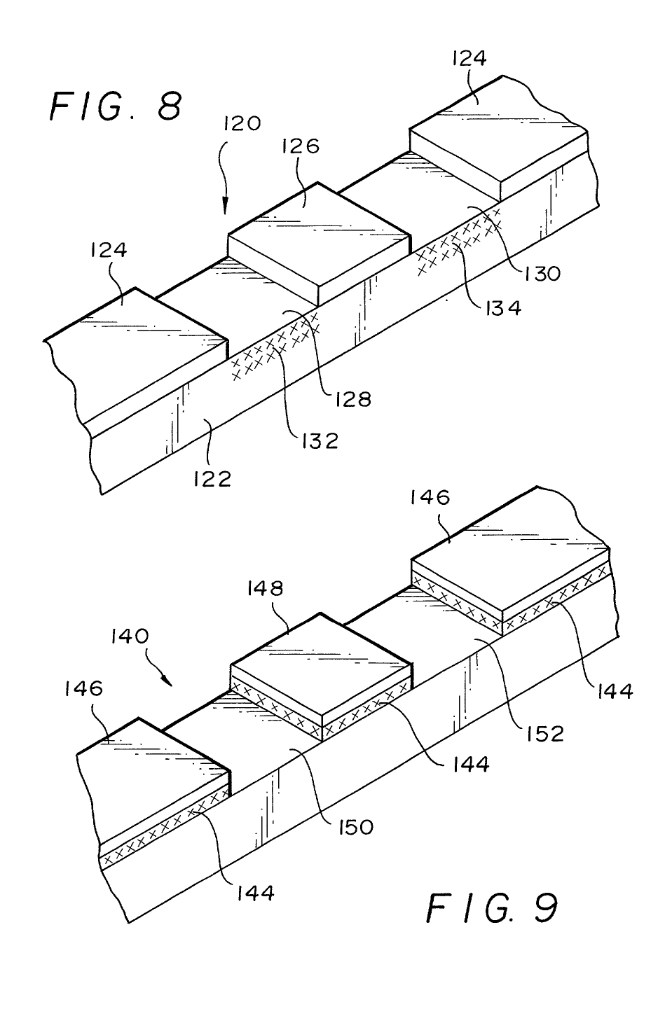

A third embodiment of the invention is illustrated at 120 in FIG. 8, wherein laser cavity 122 carries spaced electrodes 124 and 126. Sections 128 and 130 of cavity 122 between the electrodes are proton-implanted to turn them into high resistivity regions 132 and 134, respectively. This technique allows electrical isolation between the two electrodes 124 and 126 preventing a flow of unwanted current, while preserving the optical properties of the laser cavity 122.

A fourth embodiment of the invention is illustrated at 140 in FIG. 9, wherein the laser cavity 142 has a highly doped semiconductor material 144 that is used to allow good ohmic contacts between electrodes 146, 148 and the surfaced cavity 142. This layer 144 is removed from regions 150 and 152 between the electrodes. This prevents the flow of a large unwanted current between the two electrodes.

The wavelength tunable ring lasers of the present invention preferably are laterally confined ring lasers, to allow their use for optical fibers and to obtain the highest spectral purity. The lateral confinement can be provided, for example, through a ridge structure such as that described in Behfar-Rad, et al, IEEE Journal of Quantum Electronics, Vol. 28, pps. 1227-1231. The unidirectional behavior of such devices is described in the aforesaid U.S. Pat. No. 5,132,983, and the wavelength tunable lasers of the present invention preferably are unidirectional devices.

It will be understood that numerous modifications and variations of the invention as disclosed herein may be made without departing from the true spirit and scope thereof set out in the following claims.

What is claimed is:

1. A ring type optical device comprising:
a substrate;
a monolithic body on said substrate including an integral ring cavity having at least one facet for transmitting light out of said cavity;
at least first and second spaced electrodes on a surface of said body and in contact with corresponding first and second segments of said laser body;
at least first and second bias voltage sources each connected to a corresponding one of said first and second electrodes for applying bias voltages across corresponding segments of said cause said device to emit light from said facet at a nominal wavelength; and
at least one of said bias voltages being variable to vary the wavelength of said emitted light.

2. The device of claim 1, wherein said voltages applied to said electrodes cause light to propagate in cavity.

3. The device of claim 1, wherein said monolithic body is a semiconductor, and wherein said voltages applied to said electrodes cause laser light to propagate in said cavity, said variable bias voltage varying the wavelength of laser light emitted from said facet.

4. The device of claim 3, wherein said spaced electrodes are separated by first and second regions of said body.

5. The device of claim 4, wherein said first and second regions are proton implanted to be resistant to current flow between said electrodes.

6. The device of claim 4, wherein said body has a highly doped layer for ohmic contact with said electrodes, said doped layer being removed in said first and second regions between said electrodes.

7. The device of claim 6, wherein the remainder of each of said first and second regions is proton implanted

8. An optical device comprising:
a semiconductor body having at least one facet for emitting light;
first and second spaced electrodes on a common surface of said body;
first and second variable bias voltage sources connected to respective first and second electrodes for causing light of variable wavelengths to propagate in said body.

9. The optical device of claim 8, wherein said body is a laser.

10. The optical device of claim 8, wherein said body forms a closed ring cavity having a single facet.

11. The optical device of claim 10, wherein said body is proton implanted between said spaced electrodes to produce a high resistance to electrical current between the electrodes.

12. The optical device of claim 10, wherein a top layer of said body is highly doped to provide ohmic contacts for said electrodes.

13. The optical device of claim 12, wherein said body is free of said ohmic contacts in regions between said electrodes.
